(19) United States
(12) Patent Application Publication
(10) Pub. No.: US 2004/0229516 A1
(43) Pub. Date: Nov. 18, 2004

(54) Connector of a power source

(76) Inventor: Shin-Nan Kan, Hsinchu Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/437,301

(22) Filed: May 14, 2003

(51) Int. Cl. H01R 24/00

(52) U.S. Cl. 439/675

(57) ABSTRACT

The present invention relates to a connector of a power source, which provides an improved metal receiver in the main body. The receiver has its outer end being divided into several conductive slices that has a trumpet-type configuration for contacting the plug effectively to obtain a perfect electrical connection. The trumpet-type metal receiver has perfect elastic character and can prevent from elastic deformation after a long time use.

### BACKGROUND OF THE INVENTION

The present invention refers to a connector of a power source, which provides a trumpet-type metal receiver for engaging with the plug firmly and obtains perfect conductive effect.

As shown in FIG. 1 to 4, a conventional connector includes a main body (1), several conductive slice (2) received in the body (1), and a cap (3) beside the body (1). A plug (4) can be then inserted into the body (1) for electrical connection. The prior structure has usually three conductive slices (2), which can elastically contact with the surface of the plug (4). Since the conventional conductive slice (2) is provided independently, there will always be elastic deformation at use of a period of time. The contact between the conductive slice (2) and the plug (4) is not so good that the electrical connection will be worse.

Accordingly, the present invention is to overcome the drawback of the conventional product and will be described in the following description.

### BRIEF DESCRIPTION OF THE DRAWINGS

The following drawings indicate the character and improvement of the connector of a power source of the present invention.

FIG. 1 shows an exploded perspective view of a conventional connector.

FIG. 2 shows a cross-sectional plan view of the conventional connector in FIG. 1.

FIG. 3 is an assembled plan view of FIG. 2.

FIG. 4 is a cross-sectional plan view of FIG. 3 alone line A-A.

FIG. 5 is a perspective view showing a connector of a power source according to the present invention.

FIG. 6 shows an exploded perspective view of FIG. 5.

FIG. 7 shows a cross-sectional plan view of the connector in FIG. 5.

FIG. 8 shows an assembled plan view of FIG. 7.

FIG. 9 shows an end plan view of FIG. 8.

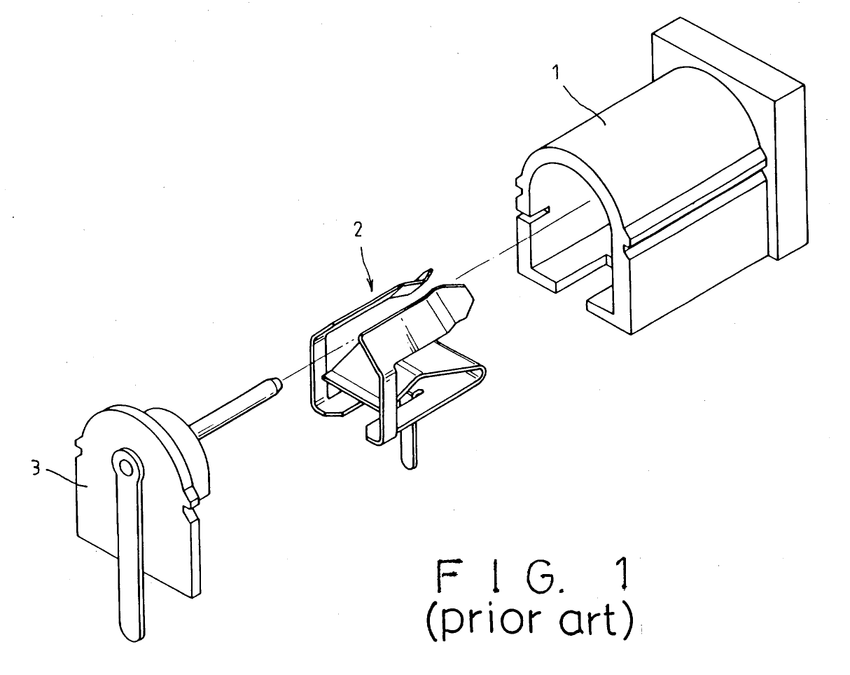

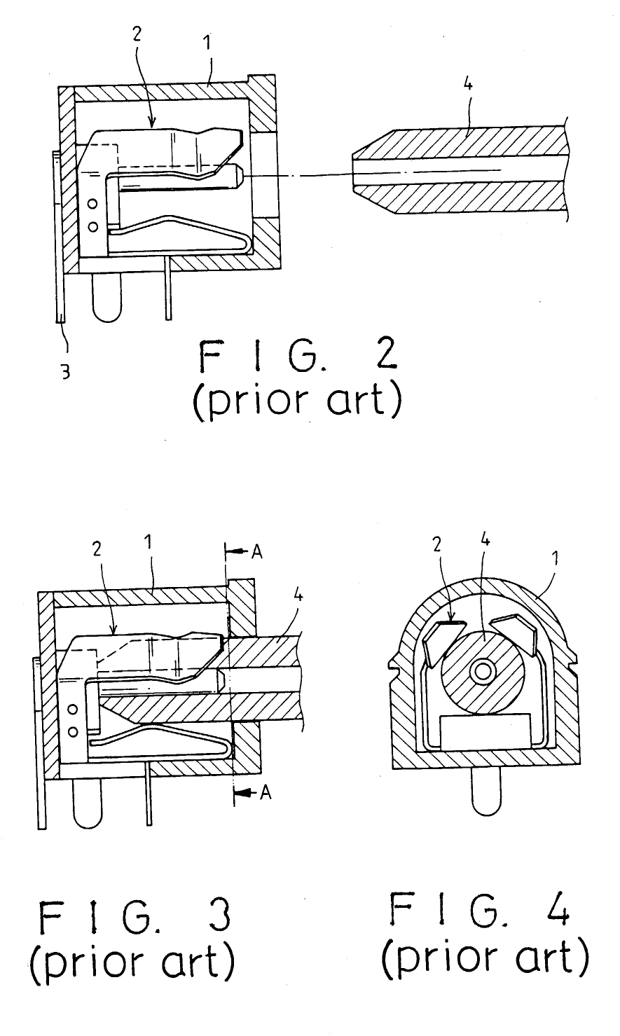

### DETAILED DESCRIPTION OF THE INVENTION

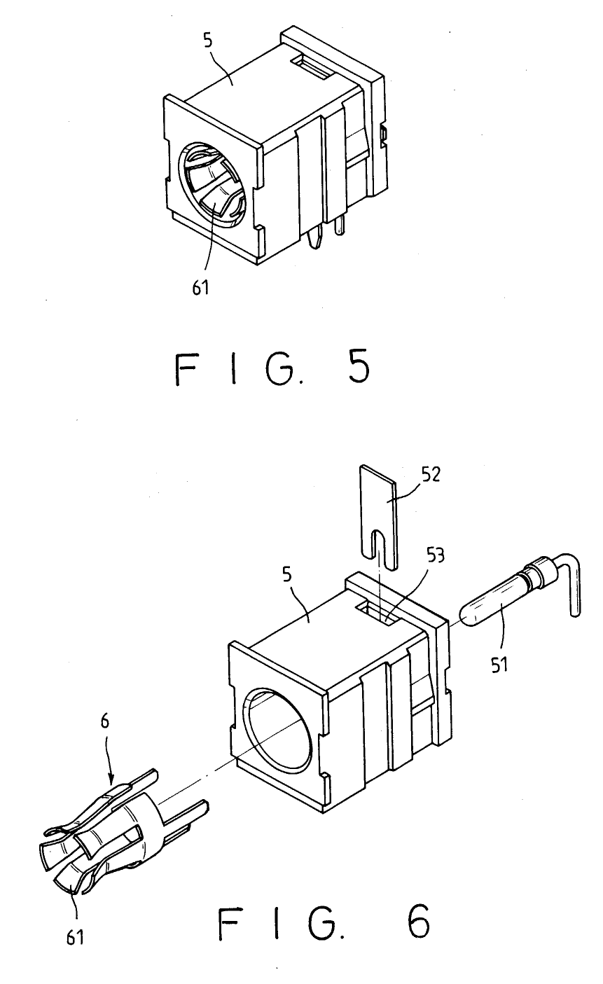

Referring firstly to FIGS. 5 and 6, the present invention relates to an improvement of a connector of a power source, which includes a main body (5), a trumpet-type metal receiver (6) mounted in the body (5), and a central pin (51). The central pin (51) can be engaged by a plate (52), which is inserted into a slot (53) on topside of the body (5). The receiver (6) has its outer end being divided into several conductive slices (61) still with a trumpet configuration.

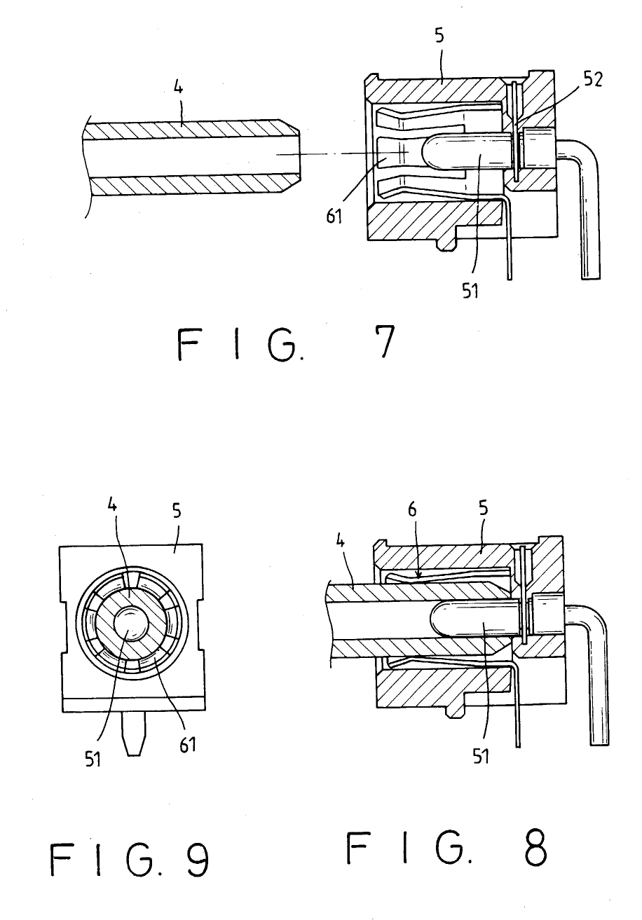

As shown in FIG. 7 to 9, when the plug (4) is inserted into the opening of the main body (5), it can be firmly engaged between the conductive slices (61) and the central pin (51). Because the conductive slices (61) are around the plug (4) and every conductive slice is still connected with each other at boot portion, the receiver (6) can obtain a perfect elastic effect to contact with the plug (4). The electrical connection will be better than a prior one since the receiver (6) has more contact points. Moreover, the trumpet-type receiver (6) can prevent from elastic deformation effectively and thus overcomes the drawback of the conventional structure.

Accordingly, the present invention obtains utility for use and should be allowed for patent. The above description is only an example of an embodiment and it can be modified under the same spirit of the invention and will be still claimed in this application.

1. (Canceled).

2. The connector as claimed in claim 3, wherein a central pin is engaged in the main body by a plate, which is inserted into a slot formed in a topside of the body.

3. A connector of a power source comprising:
a main body;
a trumpet-type metal receiver disposed in said main body, said metal receiver including a deflectable boot portion defining a divided ring configuration about an axis thereof, and a plurality of conductive slices disposed along said boot portion to extend axially therefrom, said conductive slices being spaced one from the other.
